(19) United States
(12) Patent Application Publication
(10) Pub. No.: US 2007/0268839 A1
(43) Pub. Date: Nov. 22, 2007

(54) Method and apparatus for autoconfiguring a high speed serial port

(76) Inventor: Shane Keating, Limerick (IE)

Correspondence Address: INTEL CORPORATION;c/o INTELLEVATE, LLC, P.O. BOX 52050, MINNEAPOLIS, MN, 55402, US

(21) Appl. No.: 11/435,472

(22) Filed: May 16, 2006

(51) Int. Cl. H04L 12/28; H04L 12/66

(52) U.S. Cl. 370/254; 370/463

(57) ABSTRACT

A method and apparatus for automatically configuring a high-speed serial port is provided. Configuration parameters are automatically configured for a particular serial protocol, for example, T1/J1/E1 based on the result of analyzing data transmitted from the high-speed serial port that is received by the high-speed serial port.

### FIELD

This disclosure relates to serial ports and in particular to auto configuring serial ports.

### BACKGROUND

A network processor may include a high speed serial interface for direct connection to a T1/E1/J1 framer or to a Subscriber Line Interface Circuit (SLIC)/Compresser-Decompressor (CODEC). For example, Intel® Corporation's IXP2350 network processor includes a high speed serial interface that supports a direct connection to a T1/E1/J1 framer.

T1 also referred to as a T-1 carrier is a high speed communications line that supports a data rate of 1.544 Mega bits per second (Mbps) by multiplexing 24 separate 64 Kilo bits per second (Kbps) channels into a single data stream. E1 is a European transmission format that supports data rates of 2.048 Mbps over 30 channels. J1 is variant of T1 used in Japan supporting a data rate of 1.544 Mbps over 24 channels.

The high speed serial interface is typically configured for use with a particular framer and communications protocol. A framer may include a receive framer, a receive slip buffer, a transmit framer and a transmit slip buffer. For example, the T1/E1/J1 framer may be an Intel® IXF3208 or Intel® IXF3204 with a plurality of ports each of which may operate at 1.544 Mbps or 2.048 Mbps. Each port operates independently allowing each channel to be individually configured for T1, E1 or J1.

The high speed port is configured for a particular framer by setting parameters such as, frame pulse width, frame pulse offset, frame pulse edge type, and data sampling edge type.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 illustrates a T1 frame;

FIG. 2 is a block diagram of an embodiment of a system that includes a network processor, a T1 framer and a T1 line interface unit and one T1 line;

FIG. 3 is a block diagram of an embodiment of the network processor shown in FIG. 2;

FIG. 4 is a block diagram of a serial port in the network processing engine shown in FIG. 3.

FIG. 5 is a timing diagram illustrating signals in the receive interface of the serial port controlled by the network processing engine shown in FIG. 3;

FIG. 6 is a flowchart illustrating an embodiment of a method for auto-configuring parameters for the receive interface and the transmit interface implemented by a configuration module according to the principles of the present invention;

FIG. 7 is a flowchart illustrating an embodiment of a method for auto-configuring parameters of the frame sync signal; and

FIG. 8 is a flowchart of an embodiment for auto-configuring the frame pulse offset parameter.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

Determining values of the parameters for the framer is time consuming because the values are manually selected using trial and error methods. The parameters of a high speed serial interface are automatically configured based on the result of analyzing received data according to an embodiment of the present invention. An embodiment of the invention will be described for configuring parameters of a serial interface to a T1 framer. However, the invention is not limited to a serial interface to a T1 framer; the invention can be used to configure parameters of any serial interface that includes a frame pulse signal, a data signal and a clock signal.

A T-1 link is a full duplex link that includes a four wire circuit using two pairs of unshielded twisted copper wires. One pair is used for transmit and the other pair is used for receive and transmission and reception of data can occur simultaneously. Digital data, analog voice and fax may be converted into digital pulses for transmission over the T-1 link.

T1 uses pulse code modulation and time-division multiplexing to transport 24 channels of voice and data over the Public Switched Telephone Network (PSTN). Pulse code modulation is a standard method of encoding analog audio signals in digital form. Digital Signal 0 (DS0) supports one 64 kbits/s voice channel. To carry a typical phone call, the analog voice is sampled 8,000 times per second to provide an 8-bit pulse-code modulated signal (64 Kbps) with each 8-bit word representing each sample. Multiple DSOs are multiplexed together, with a Digital Signal 1 (DS1) having 24 DS0s. With 24 DSO signals each having a 64 Kbps data rate, the data rate of T-1 (DS-1) is 1.544 Mbps.

The DS1 rate is 1.544 Mega bits per second (Mbps) full duplex, that is, 1.544 Mbps both downstream and upstream. The data stream is split into time slots or frames, with each of the 24 channels allocated 8-bits per frame. Thus, each frame has 193 bits (24 channels×8 bits) of data (payload) and a framing bit. There are 8,000 frames per second; therefore the timeslot for one frame is 125 microseconds.

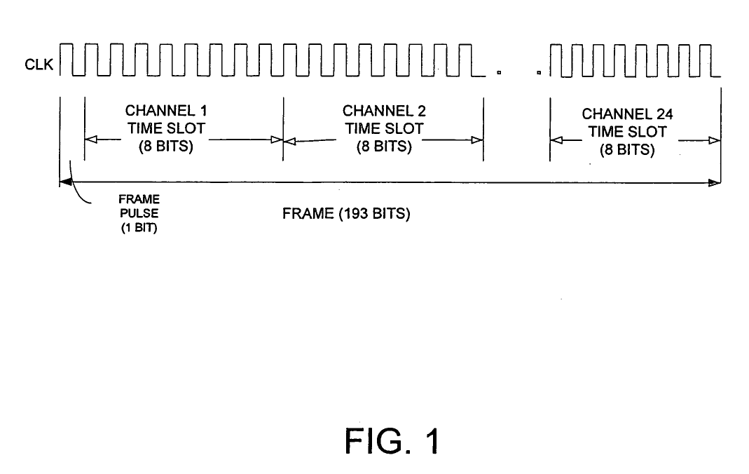

FIG. 1 illustrates a T1 frame. As shown, the frame includes 193 bits, 8-bits for each of the 24 channels and a framing bit. Frame synchronization is used to identify each frame through the use of the framing bit in each frame. Thus, the 1.544 Mbps DS1 rate includes 8 kbits of framing data (1 for each of the 8000 frames) and 1.536 Mbits of data (24×64 kbits).

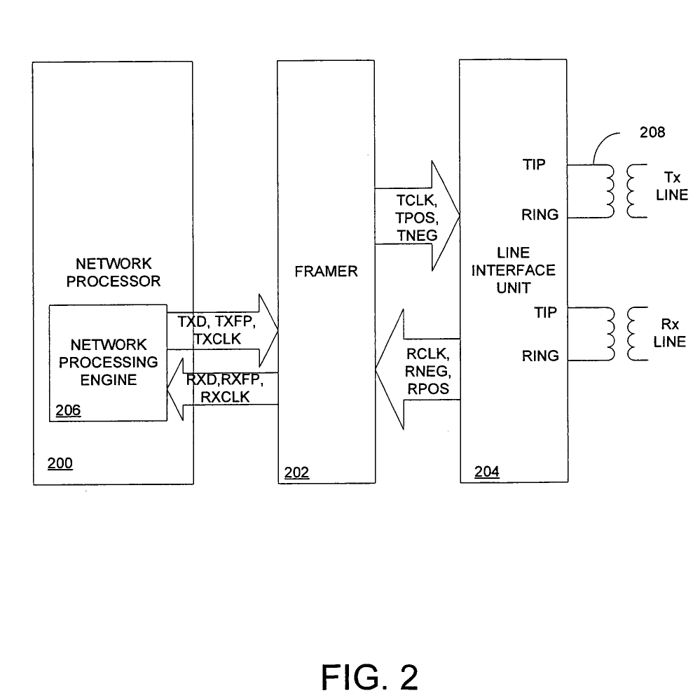

FIG. 2 is a block diagram of a system that includes a network processor 200, a T1 framer 202, a T1 line interface unit 204 and one T1 line. The T1 line interface unit 204 is the physical interface to a T1 carrier. The T1 line interface unit 204 includes a receive circuit and transmit circuit which may be coupled through transformers 208 to the receive and transmit lines (RxLine, TxLine) of a Wide Area Network (WAN). The T1 carrier operates over two separate sets of wires, transmit wires (Transmit Tip (T1 P) and Transmit Ring (RING)) and receive wires (Receive Tip (T1 P) and Receive Ring (RING)), which may be twisted pair. The framer 202 synchronizes data received from the line interface unit 204 and formats data to be transmitted by the line interface unit 204 over the WAN.

In one embodiment the network processor may be Intel® Corporation's IXP2350 network processor and the framer may be an Intel® IXF3208 or Intel® IXF3204.

A receiver interface in the line interface unit 204 receives twisted-pair input via a center-tapped 1:2 transformer 208. Positive pulses are received on the receive tip and negative pulses on the receive ring. Recovered data is output for use by the framer 202 on two signals (RPOS, RNEG) in bipolar mode or on one signal RDATA in unipolar mode. A clock recovered from the received serial stream is output on an RCLK signal.

In the embodiment shown, the interface between the line interface unit 204 and the framer 202 includes a receive interface and a transmit interface. The receive interface includes three signals RPOS, RNEG and RCLK. The transmit interface also includes three signals TCLK, TPOS and TNEG. In bipolar mode, the POS and NEG are positive and negative sides of a bipolar pair and are the pair either includes data received from the twisted-pair line or data to be transmitted onto the transmitted-pair line. The RCLK is recovered from the input signal and the transmit data inputs are sampled on the falling edge of the TCLK.

The framer 202 and line interface unit 204 may include support for more than one T1/E1/J1 link also referred to as a trunk or port. Each port may be independently configured for 56 Kbps (E1) or 64 kbps (T1/J1). For example, the Intel® IXF3208 framer has 8 T1/E1/J1 ports and the Intel® IXF3204 framer has 4 T1/E1/J1 ports.

A transmitter interface in the line interface unit 204 clocks data serially into a PSTN (or WAN) through two signals (Transmit Tip, Transmit Ring) in bipolar mode or through one signal (Transmit data) in unipolar mode. A transmit clock supplies the input synchronization. The transmit data is received from the framer 202 and may sample the data to be transmitted on the falling edge of the clock.

In the embodiment shown, the line interface unit 204 and framer 202 are separate devices, however, in an alternate embodiment, the line interface unit 204 and framer 202 may be combined in a single device.

There is also a separate receive interface and transmit interface for transferring data between the framer 202 and the network processor 200. In the embodiment shown, the receive interface includes three signals, a receive clock, a receive frame pulse, and receive serial data. The transmit interface also includes three signals, a transmit clock, a transmit frame pulse, and transmit serial data.

The framer 202 communicates with the network processor port (receive interface and transmit interface) using 3 signals per direction (clock (TXCLK, RXCLK), data (TXD, RXD) and frame pulse (TXFP, RXFP)). The data stream includes frames which are typically delimited by the frame pulse. Each frame includes a plurality of timeslots (TS) and optionally a single frame bit as discussed in conjunction with FIG. 1. The maximum frame size is 1024 bits (128 time slots) and the data frame may be offset from the frame pulse by 0-1023 bit positions. The offset is considered to be the delay (in data cycles) between the first bit of data in the frame and the corresponding frame pulse.

The receive interface and transmit interface may be tested through the network processor 200, framer 202 and line interface unit 204 by connecting the Tx Line to the Rx Line to provide a loopback. This allows received data to be compared with the data that was transmitted. In one embodiment the loopback from the Tx line to the Rx Line is provided by coupling test equipment such as a Sprint Communications® Smartbits® SMB-2000 system with SmartBits® WN-3442A (E1) and WN-3441A (T1) smartcards to the Tx Line and the Rx line. In one embodiment, data generated by a configuration module in the network processor 200 using a communications protocol, may be transmitted through the transmit port, looped back through a Wide Area Network (WAN) and received by the receive port. In an alternate embodiment, the data is generated by the test equipment and transmitted through the line interface unit 204 and framer 202 to the receive port in the network processing engine 206.

In other embodiments other methods for returning the transmit data to the receive port may be used. For example, data may be looped back through the framer by configuring the framer in digital loopback mode. In digital loopback mode, the framer operates in internal loopback mode with data being sampled on the TXD line, looped back internally in the framer 202 and then sent back to the network processing engine on the RXD line. Therefore, data is passed from the serial port transmit interface, through the framer transmit interface and back through the framer receive interface and serial port receive interface.

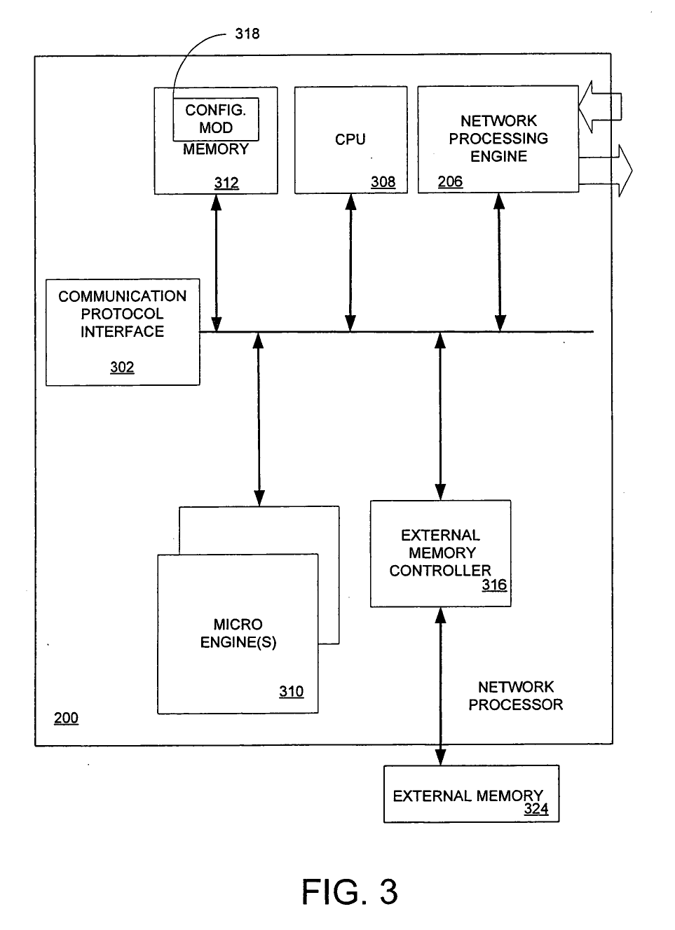

FIG. 3 is a block diagram of an embodiment of the network processor 200 shown in FIG. 2. The network processor 200 includes a communications protocol interface 302, an external memory controller 316, a processor (Central Processing Unit (CPU)) 308, a plurality of micro engines 310 and at least one network processing engine 206. One of the plurality of network processing engines includes support for T1/E1/J1 Time Division Multiplexing (TDM) links.

The micro-engines 310 may perform packet forwarding and traffic management operations. In an embodiment, each micro engine 110 is a 32-bit processor. The CPU 108 may be a 32 bit general purpose processor which may be used for offloading control plane tasks and handling exception packets from the micro engines 110.

The external memory controller 316 controls access to external (off-chip) memory 324 which may be used for buffering packets and large data structures, for example, route tables and flow descriptors. The internal (on-chip) memory 312 is shared by all of the micro engines 112. The external memory 324 may be Rambus Dynamic Random Access Memory (RDRAM), Double Data Rate Dynamic Random Access Memory (DDR RAM), Synchronous Dynamic Random Access Memory (SDRAM), Dynamic Random Access Memory (DRAM), Static Random Access Memory (SRAM) or any similar type memory.

The communications protocol interface 302 buffers network packets as they enter and leave the network processor 200. In one embodiment, the communications protocol interface 302 may include support for the Media Access Control (MAC) protocol with Direct Memory Access (DMA) capability which handles packets as they enter and leave the network processor 200.

The network processing engine 2-6 includes at least one serial port which may be a full-duplex interface to a T1/E1/J1 framer as discussed in conjunction with FIG. 2. A configuration module 318 which may be stored in internal memory 312 includes program instructions which may be executed by the CPU 308 for configuring serial ports in the network processing engine 2-6 for a particular serial protocol. In another embodiment, the configuration module 318 may be stored in external memory 324. The configuration module 318 will be described in greater detail later.

By allowing certain parameters such as frame length/offset, frame signal polarity, data endianess, to be programmable, the serial port can be configured to support protocols such as T1, E1, J1, General Circuit Interface (GCI) and Multi Vendor Integration Protocol (MVIP). MVIP supports integration for voice processing, FAX, data communications, video conferencing and other computer technologies that require connection to the telephone network. These parameters may be auto configured according to the principles of the present invention.

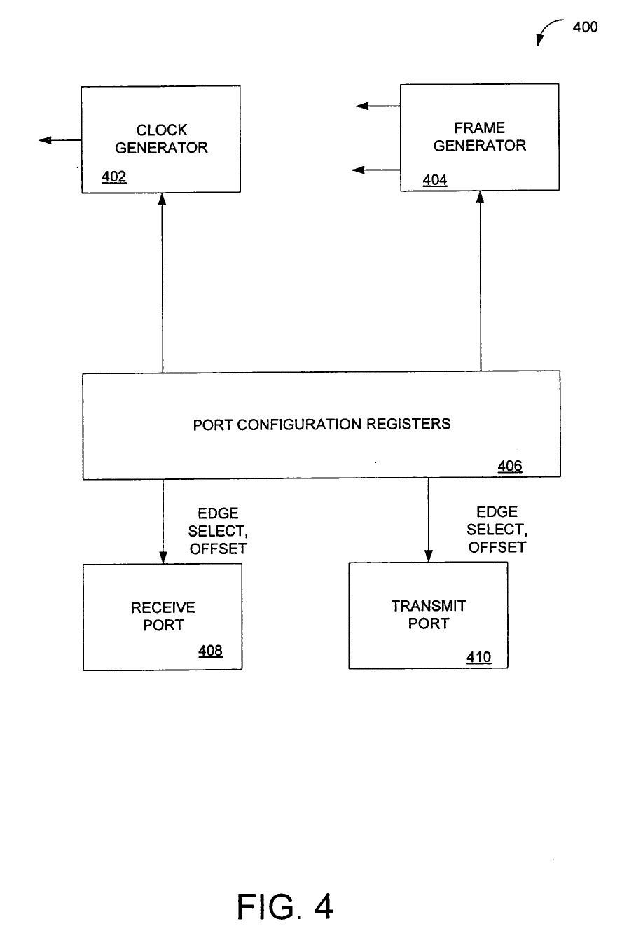

FIG. 4 is a block diagram of a serial port 400 in the network processing engine 206 shown in FIG. 3. The serial port 400 refers to a full-duplex serial interface that includes 3 signals (clock, data, and frame pulse) for a receive interface (port) 408 and 3 signals (clock, data, and frame pulse) for a transmit interface (port) 410.

In order to support different serial signaling protocols used by different serial protocols, parameters of the signals for the receive port 408 and transmit port 410 may be configured. In one embodiment, parameters of the receive clock, receive frame pulse, and receive serial data in the receive interface and the transmit clock, a transmit frame pulse, and transmit serial data in the transmit interface may be auto-configured and stored in port configuration registers 406 in the port 400. The port 400 also includes a clock generator 402 and a frame generator 404 which are shared by the receive port 408 and the transmit port 410.

The port configuration registers 406 store selected configuration parameters, for example, the polarity, width, offset and source of both the receive frame pulse and the transmit frame pulse. Configuration parameters for data rate, data polarity, data sample clock edge and bit endianess, that is, whether the least significant bit or the most significant bit of each byte is transmitted first in both the receive data and transmit data stream may also be stored in the port configuration registers 406.

Signaling protocol configuration parameters for a port 400 are determined by analyzing data received by the receive interface. Data is analyzed until all parameters have been determined correctly.

Signaling protocol parameters that may be automatically configured are shown in Table 1 below:

TABLE 1

| Signal | Parameter | Possible Values |
|---|---|---|
| Clock | Direction | Input/Output |
| Frame Pulse | Source | Input/Output |
| Frame Pulse | Type | Low/High level; Falling/Rising edge |
| Frame Pulse | Width | Number of clock cycles |
| Frame Pulse | Sample Clock Edge | Falling/Rising edge |
| Frame Pulse | Offset | Number of data cycles |
| Data | Clock Edge | Falling/Rising |
| Data | Rate | Full/Half Clock Rate |
| Data | Polarity | Inversion; No inversion |
| Data | Bit Endianess | LSB/MSB first |

The clock signal may be an input signal or an internal programmable clock divider may output an approximate clock whose average frequency is within the range 100 KHz-20 MHz.

The frame pulse signal may be generated internally (output) or received (input), detected as active low/high, falling edge or rising edge. The width of the internally generated frame pulse signal is programmable. The data and frame pulse signals may be sampled or generated on either clock edge (rising or falling). The data endianess can be programmed. The clock can run at the data rate or double the data rate. The frame pulse signal offset is programmable up to 1023 bits.

As previously discussed, the network processing engine 206 may include a plurality of serial ports. Each port is similar to the port discussed in conjunction with FIG. 4 and shares no configuration information with the other ports.

In an embodiment after completion of auto configuration of the signaling protocol parameters for a receive port and transmit port in an Intel® IXP2350 coupled to an Intel® IXF3408, the parameter values shown in Table 2 below were selected:

TABLE 2

| | | |
|---|---|---|
| Signal | Parameter | Value |

Transmit Port:

| | | |
|---|---|---|
| Clock | Direction | Input |
| Frame Pulse | Source | Input |
| Frame Pulse | Type | Falling edge |
| Frame Pulse | Width | 2 clock periods |
| Frame Pulse | Sample Clock Edge | Rising edge |
| Frame Pulse | Offset | 0 clock periods |
| Data | Clock Edge | Rising |
| Data | Rate | Full |
| Data | Polarity | No inversion |
| Data | Bit Endianess | MSB first |

Recieve Port:

| | | |
|---|---|---|
| Clock | Direction | Input |
| Frame Pulse | Source | Input |
| Frame Pulse | Type | Falling edge |
| Frame Pulse | Width | 2 clock periods |
| Frame Pulse | Sample Clock Edge | Falling edge |
| Frame Pulse | Offset | 0 clock periods |
| Data | Clock Edge | Falling |
| Data | Rate | Full |
| Data | Polarity | No inversion |
| Data | Bit Endianess | MSB first |

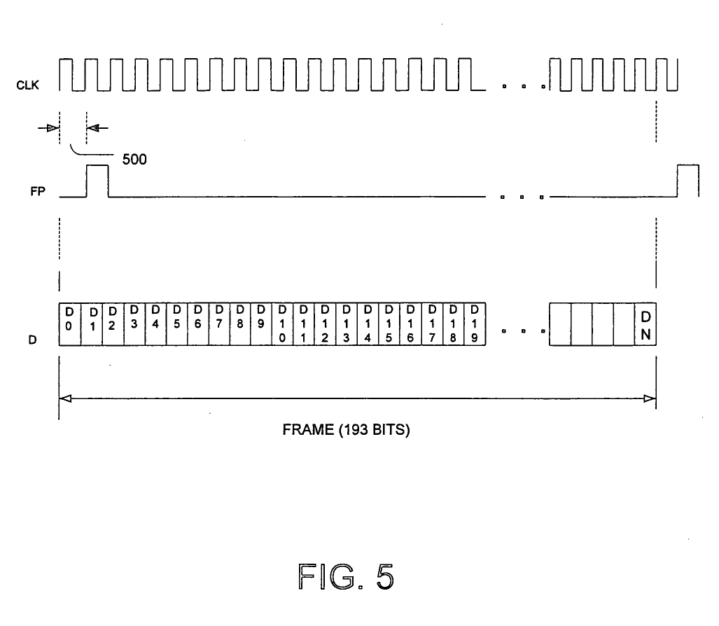

FIG. 5 is a timing diagram illustrating signals in the receive interface of the serial port controlled by the network processing engine 206 shown in FIG. 3. The clock (CLK) is a periodic signal with a frequency that is dependent on the data rate of the selected serial protocol. For example, in one embodiment, the clock may be one, two or four times the frequency of a base clock, with the base clock being 1.536 MHz, 1.544 MHz or 2.048 Mhz. The source of the clock, that is, the clock direction is configurable. The “clock direction” may be “output”, that is, the clock is generated by the network processing engine 206 or the clock direction is “input”, that is, the clock is generated external to the network processing engine 206.

A frame pulse (FP) signal may be used to indicate the start of each frame. As shown in FIG. 5, the frame pulse signal has an active pulse of a short duration once every frame period. The period of the frame pulse signal is dependent on the data rate of the selected serial protocol. For example, for a 1.544 Mbps T1 port, the frame period is 125 micro seconds.

The edge of the clock (CLK) to sample the active pulse may be configured to be the rising or falling edge. Other parameters of the frame pulse signal that may be configured include the delay of the active pulse from bit 0 of the frame 500 (offset: number of data cycles), the polarity of the active pulse (type: high or low level) and the width of the active pulse (width: clock cycles).

The edge of the clock (CLK) to sample data may also be configured to be either rising or falling. Other parameters of the data signal that may be configured include the bit endianess, that is, whether the Most Significant bit of a byte (8 bits) or the Least Significant bit of a byte is transmitted/received first on the serial data signal and the data rate (rate: full or half)

In the embodiment shown in FIG. 5, the frame pulse signal has been configured for frame pulse sample clock edge set to falling edge, frame pulse width set to one clock cycle, frame pulse offset set to 1 clock period and the frame pulse type set to high level and rising edge. The rising edge of the frame pulse signal provides an indication of the start of a frame and corresponds to the arrival of the second bit (data 2) of the N bits of the frame. The second bit (data 2) of the received data is coincident with the rising edge of the frame pulse signal because the frame pulse offset is one clock period.

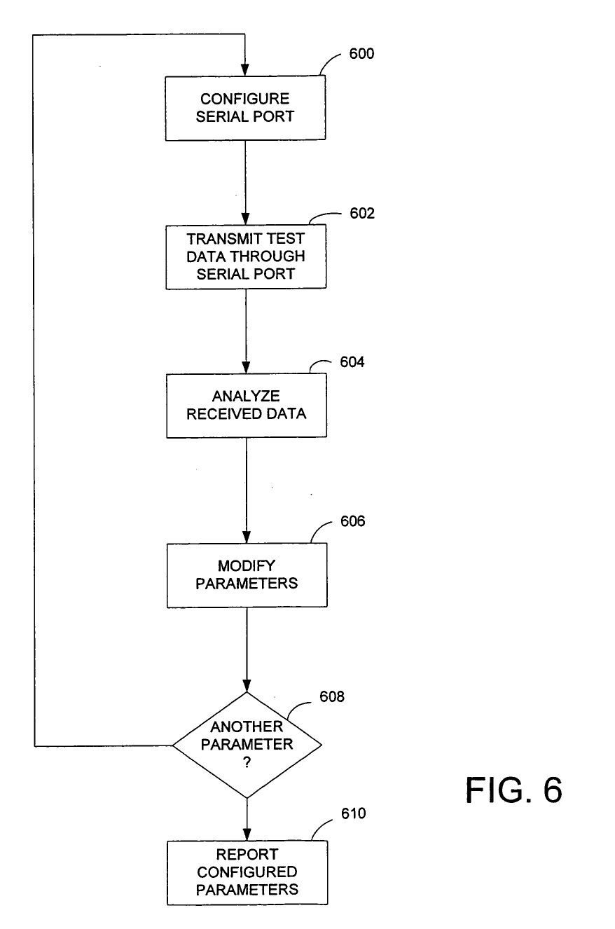

FIG. 6 is a flowchart of an embodiment of a method for auto-configuring parameters for the receive interface and the transmit interface implemented by a configuration module 318.

At block 600, known parameters for the receive interface and the transmit interface of the serial port 400 are initialized in the network processing engine 206. In one embodiment, the known parameters include frame pulse sample clock edge and data clock edge. These parameters are stored for the serial port in the network processing engine 206 and allow the other parameters to be auto-configured. A clock is assumed to be supplied, and the clock direction parameter is set to “input”. Processing continues with block 602.

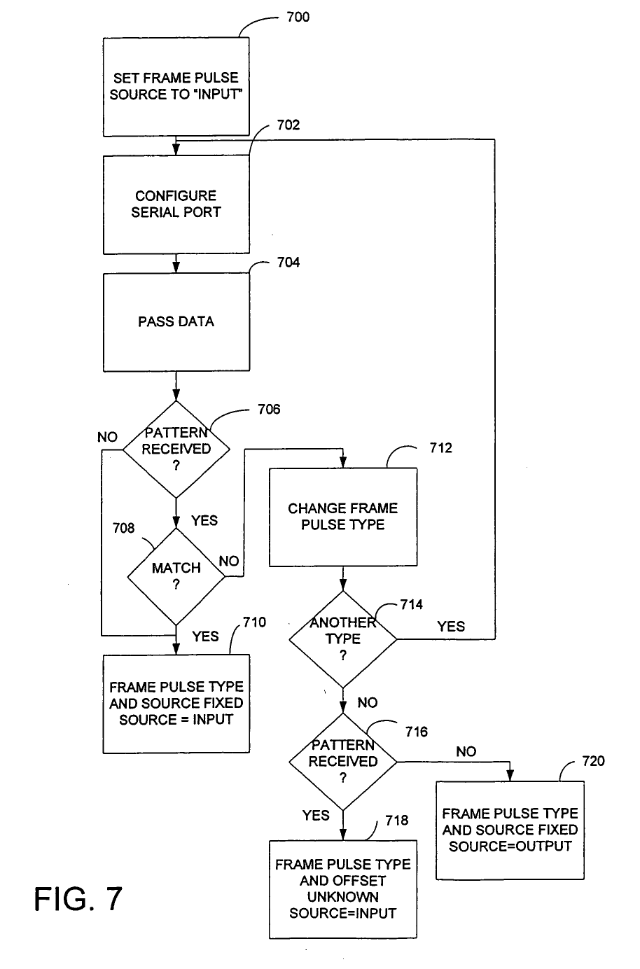

At block 602, in one embodiment data generated by the configuration module 318 is transmitted through the transmit interface of the serial port 400 through the framer 202 and line interface unit 204 and back to the receive interface of the serial port 400. The data pattern that is transmitted is dependent on the parameter that is being configured. The frame sync parameters are configured first in order to allow data to be received and transmitted through the serial port. The configuration of the parameters for the frame sync signal will be described later in conjunction with FIG. 7. Processing continues with block 604.

At block 604, the configuration module 318 analyzes the received data dependent on the parameter that is being determined. After the data has been analyzed and the value of the parameter determined, processing continues with block 606.

At block 606, the values of the determined parameters are set by the configuration module in one or more port configuration registers 406 in the serial port 400. For example, by setting or clearing a respective bit in the configuration registers 406. Processing continues with block 608.

At block 608, if there is another parameter value to be determined, processing continues with block 600. The frame pulse source is determined first because receiving a frame pulse is critical, if the source is incorrect, no data is received and thus other parameters cannot be determined. After the frame pulse source is determined, the frame pulse sample clock edge and data clock edge parameters are determined so that data can be received. In one embodiment, the values of the other parameters are determined in the following order: frame pulse type, frame pulse offset, data polarity and bit endianess.

However, in other embodiments, after frame pulse source, sample clock edge and data clock edge parameters have been determined, the values of the other parameters may be determined in any order.

If all parameters for the data, frame sync and clock have been determined, processing continues with block 610.

At block 610, the values selected for the parameters by the configuration module 318 may be reported. For example, in one embodiment, the parameter values may be displayed on a display by any user interface program well-known to those skilled in the art. In an alternate embodiment, after the values of the parameters have been determined, they may be stored for later use by firmware. For example, the stored port configuration parameters may be used by firmware to configure the serial port 400 in the network processor 200 each time power is applied to the network processor 200.

FIG. 7 is a flowchart illustrating an embodiment of a method for auto-configuring parameters of the frame sync signal. As shown in Table 1, the frame sync signal parameters include sample clock edge which may be set to a falling or rising edge, offset which may be set to a number of clock periods after bit 0 of the start of the frame, width which may be set to a number of clock periods and type which indicates whether the frame pulse is a high or low level and whether the pulse is sampled on the rising or falling edge of the clock.

As discussed in conjunction with FIG. 6, prior to starting auto-configuration, the parameters for frame sync sample clock edge and data sample clock edge are set to known values, either a “rising edge” or a “falling edge”. Also the clock direction is set to be “input”, that is, it is assumed that an external clock is being supplied.

Having set these parameters, the other frame sync signal parameters may be auto configured, that is, type, source, width and offset by passing data through the serial port and analyzing the received data.

At block 700, the source of the frame sync pulse source may be an “input” or an “output”, that is, it may be provided by an external source or generated internally in the port. In one embodiment, in order to determine the source of the frame sync pulse, it is assumed that the frame sync pulse source is external and the value of the frame sync pulse source parameter is set to “input”. If the configuration module 318 detects two consecutive frame pulses on the frame pulse signal, the frame sync pulse source parameter is set correctly. Processing continues with block 702.

At block 702, other parameters of the signals are set in the port configuration registers 406. For example, the parameters for frame sample clock edge and data sample clock edge are set to known values so that other frame sync parameters may be configured. Also, the frame pulse width may be set dependent on whether the frame sync pulse source is external or internal. If the frame pulse source is external, the frame pulse width configuration parameter is ignored. If the frame pulse source is internal, the frame pulse width configuration parameter is set to the width of the internal frame pulse. Processing continues with block 704 to auto-configure other parameters of the signals.

At block 704, frame synchronization data, for example, a unique non-constant bit pattern is generated by the auto configuration module 318 and transmitted through the transmit interface (port) 410 of the serial port 400, and is looped back through the line interface unit 204 and back through the framer 202 to the receive interface (port) 408 of the serial port 400. While data is being transmitted and received, the data stream may be varied to configure frame sync signal parameters. Processing continues with block 706.

At block 706, if any data pattern is received, processing continues with block 708 to determine if the pattern matches. As there are four possible values of frame pulse type, that is, (1) high level; (2) low level; (3) rising edge; and (4) falling edge, it may take four iterations to find the correct frame pulse type. If a data pattern is not received, processing continues with block 712 to try another frame pulse type.

At block 708, if the pattern matches, processing continues with block 710. If not, processing continues with block 712.

At block 710, the pattern was received and the pattern matches, thus, the values stored for the frame pulse parameters (width, frame type and source) in the port configuration registers 406 are correct. The frame sync pulse source is set to “input”. Auto configuration of the frame pulse signal parameters is complete.

At block 712, the frame pulse type is modified to one of the four possible values that have not already been tested and processing continues with block 714 to check the current parameter set for the frame pulse type.

At block 714, if all possible values for the frame pulse have been tested, processing continues with block 716. If not, processing continues with block 702, to modify the frame pulse type parameter.

At block 716, if a pattern was received, processing continues with block 718. If not, processing continues with block 718.

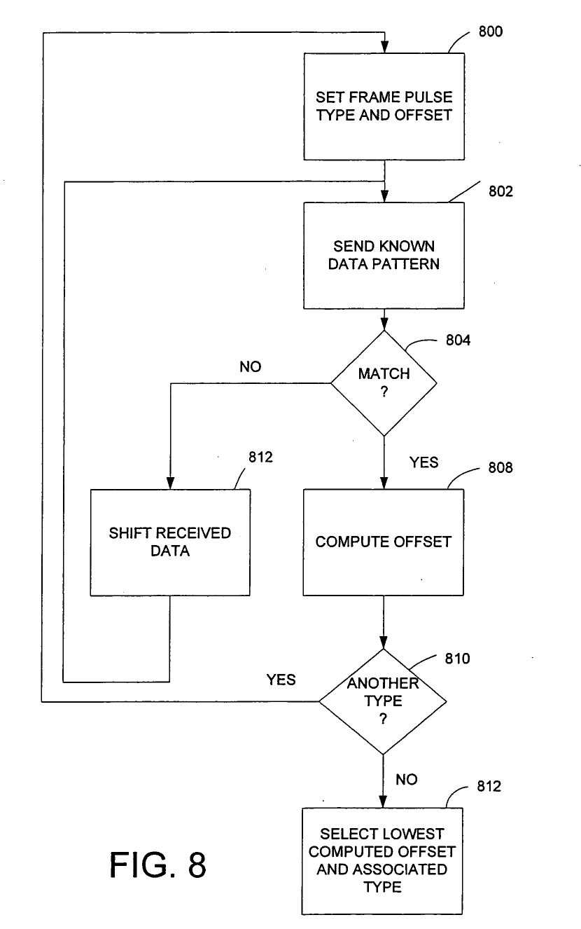

At block 718, as a pattern was received but did not match, the source is set to “input”. The type and offset parameters for the frame pulse are unknown. However, they may be determined using a method that will be described later in conjunction with FIG. 8.

At block 720, a pattern was never received and all variations of the frame sync type parameters were attempted. The frame sync source is set to “output”, that is, generated internally instead of generated externally. As an internal frame pulse is supplied, the frame pulse type and frame pulse source may be set to default values based on the supplied frame pulse signal. Auto configuration is complete.

After the frame pulse source has been correctly configured, the frame pulse offset may be determined. FIG. 8 is a flowchart illustrating an embodiment of a method for auto configuring the frame pulse offset parameter. At block 800, an arbitrary frame pulse type is set, for example, “rising edge” and an arbitrary frame pulse offset, for example, ‘0’ is selected. Processing continues with block 802.

At block 802, a known data pattern of N bits per frame is sent. The data pattern forms N/8 unique bytes or is a pattern of unique bytes, for example, an incrementally increasing stream of bytes 0, 1, 2 . . . , N/8. Processing continues with block 804.

At block 804, the received data pattern is checked with the transmitted pattern to determine if there is a match. If so, the selected frame pulse offset is correct and processing continues with block 806. If not, the selected frame pulse offset is not correct and processing continues with block 810.

At block 806, the frame pulse offset is the amount by which the bits in the known data pattern have been shifted prior to detecting a match. Processing continues with block 808.

At block 808, the frame pulse offset differs with the selected frame type. For example, referring to the example in FIG. 5, if the frame pulse sample clock edge is configured as “falling edge” a different offset is computed. To counteract this, the computation of the frame pulse offset is performed with the frame pulse type configured for “rising edge”, “falling edge”, “high level” and “low level”. If there is another type to be computed, processing continues with block 800. Otherwise, processing continues with block 810.

At block 810, the frame pulse type that provides the lowest frame pulse offset is selected. Thus, the frame pulse type is also configured in conjunction with the configuration of the frame pulse offset.

After the frame pulse source, type and offset has been determined, the data polarity parameter is determined by setting the value of the data polarity parameter to one of two possible values, that is, “inversion” or “no inversion”. A known data pattern is sent and bit-inversion of the received data pattern is tested. For example, the known data pattern may be incrementing bytes 0x00, 0x01, 0x02, . . . which would be returned as bytes 0xFF, 0XFE, 0xFD, . . . , if the data polarity parameter is incorrect. If the pattern has been bit-inverted, the value of the data polarity parameter is correct. If not, the value of the data polarity parameter is switched to the other value.

The bit endianess parameter may be configured by sending a known data pattern and testing for bit-reversal of that data pattern. For example, the known pattern may be incrementing bytes 0x01, 0x02, 0x03, which would be returned as bytes 0x00, 0x80, 0xC0 if the bit endianess parameter is incorrect. If the pattern has been bit-reversed, the bit endianess parameter is switched to the other value.

The data rate parameter may be auto-configured by sending any known pattern and checking for extra or missing bits in the return data. For example, if the data rate is set incorrectly to double the actual clock rate, each bit in the returned data will appear twice. If the rate is set incorrectly to half the actual clock rate, the every second bit in the returned data will be missing.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a serial port; and
a configuration module, the configuration module capable of analyzing data received through the serial port, the data generated by the configuration module, transmitted through the serial port using a communications protocol and returned through the serial port, based on the analyzed data, the configuration module capable of determining a signaling protocol parameter to allow the serial port to communicate using the communications protocol.

2. The apparatus of claim 1, wherein the serial port includes a receive interface and a transmit interface.

3. The apparatus of claim 1, wherein the data is transmitted to a wide area network (WAN).

4. The apparatus of claim 2, wherein the receive interface includes a receive data signal, a receive frame pulse signal and a receive clock and the transmit interface includes a transmit data signal, a transmit frame pulse signal and a transmit clock.

5. The apparatus of claim 1, wherein the communications protocol is T1.

6. The apparatus of claim 1, wherein the signaling protocol parameter is frame pulse type.

7. The apparatus of claim 1, wherein the signaling protocol parameter is frame pulse source.

8. The apparatus of claim 1, wherein the signaling protocol parameter is frame pulse offset.

9. The apparatus of claim 1, wherein the communications protocol is Compresser-Decompressor (CODEC)/Subscriber Line Interface Circuit (SLIC).

10. A method comprising:
analyzing data received through a serial port, the data generated by a configuration module using a communications protocol, transmitted through the serial port and returned through the serial port; and
based on the analyzed data, determining a signaling protocol parameter to allow the serial port to communicate using the communications protocol.

11. The method of claim 10, wherein the serial port includes a receive interface and a transmit interface.

12. The method of claim 10, wherein data is transmitted to a Wide Area Network (WAN).

13. The method of claim 11, wherein the receive interface includes a receive data signal, a receive frame pulse signal and a receive clock and the transmit interface includes a transmit data signal, a transmit frame pulse signal and a transmit clock.

14. The method of claim 10, wherein the communications protocol is T1.

15. The method of claim 10, wherein the signaling protocol parameter is a frame pulse type.

16. The method of claim 10, wherein the signaling protocol parameter is a frame pulse source.

17. The method of claim 10, wherein the signaling protocol parameter is a frame pulse offset.

18. The method of claim 10, wherein the communications protocol is Compresser-Decompressor (CODEC)/Subscriber Line Interface Circuit (SLIC).

19. An article including a machine-accessible medium having associated information, wherein the information, when accessed, results in a machine performing:
analyzing data received through a serial port, the data generated by a configuration module, transmitted through the serial port using a communications protocol and returned through the serial port; and
based on the analyzed data, determining a signaling protocol parameter to allow the serial port to communicate using the communications protocol.

20. The article of claim 19, wherein the communications protocol is T1.

21. The article of claim 19, wherein the signaling protocol parameter is a frame pulse type.

22. A system comprising:
dynamic random access memory; and
a network processor coupled to the dynamic random access memory, the network processor comprising:
a serial port; and
a configuration module, the configuration module capable of analyzing data received through the serial port, the data generated by the configuration module, transmitted through the serial port using a communications protocol and returned through the serial port, based on the analyzed data, the configuration module capable of determining a signaling protocol parameter to allow the serial port to communicate using the communications protocol.

23. The system of claim 22, wherein the communications protocol is T1.

24. The system of claim 22, wherein the signaling protocol parameter is a frame pulse type.
